(19) United States
(12) Patent Application Publication
(10) Pub. No.: US 2016/0257019 A1
(43) Pub. Date: Sep. 8, 2016

(54) METHOD AND DEVICE FOR MACHINING A SUBSTRATE

(71) Applicant: MELZER MASCHINENBAU GMBH, Schwelm (DE)

(72) Inventor: Bernhard BAIST, Gevelsberg (DE)

(73) Assignee: Melzer Maschinenbau GmbH, Schwelm (DE)

(21) Appl. No.: 15/031,080

(22) PCT Filed: Dec. 4, 2014
(86) PCT No.: PCT/DE2014/000619

§ 371 Date: Apr. 21, 2016

(30) Foreign Application Priority Data
Jan. 13, 2014 (DE) 10 2014 000 133.4

(51) Int. Cl. B26F 1/40; G06K 19/077; B26F 1/44

(52) U.S. Cl. CPC B26F 1/40; B26F 1/44; G06K 19/07718

(57) ABSTRACT

A method for machining a flat substrate having at least one layer passes the substrate in the form of a strip, web or sheet through at least one machining tool together with a strip-like, web-like or sheet-like filler material on different levels; the substrate is positioned and held, more particularly in the vicinity of the machining tool; at least one punch-type component of the machining tool creates an opening, more particularly a window, at a predeterminable point on the substrate; the component is then moved to an area outside the opening; and in another stroke an element that matches the cross-section of the opening is punched out of the filler material by the component of the machining tool, is moved by the component towards the opening in the clamped substrate, and is placed by the component in the opening in the substrate.

The invention relates to a method for machining of a flat substrate having at least one layer.

It is generally known to introduce window openings into substrates, which openings serve to accommodate electronic components, chips or the like, for example. If the substrate consists of multiple layers, a correspondingly configured opening is introduced into each individual layer, wherein the layers are subsequently positioned relative to one another. Tolerances that result from machining inaccuracies can bring about the result that placement of the component into the respective opening is made difficult. This causes problems, in particular, in the production of cards.

DE 196 20 597 C2 relates to an apparatus for different machining of consecutive sections of layer material, such as paper or the like, on a lifting device in the region of machining locations, having an apparatus base as well as a lifting device mounted on it, which can be driven with a lifting drive, having at least two separate first and second tool units, which contain separate tools, such as lifting punches for perforation or the like, and can be controlled to go into operating states, namely machine the layer material in machining operation, and do not perform any machining in a rest state, as well as having a running direction and a guide for the layer material that determines the layer plane, wherein the tool units are disposed next to one another, transverse to the running direction.

A method for the production of chip carriers, particularly chip cards, can be derived from DE 196 34 473 C2; in this method, proceeding from basic substrate material guided in endless manner as roll material or as sheet material, introduction of a window into the basic substrate material and, subsequently, covering of the basic substrate material with a cover layer material and placement of components onto the basic substrate material in a component placement station takes place, and in which method the basic substrate material is provided with a chip module in the component placement station, in such a manner that the chip module is accommodated by the window opening.

The invention is based on the task of making available a method and a device for machining of a flat substrate having at least one layer, by means of which position-precise introduction of a filler material into a previously produced opening within the substrate is possible.

The task is accomplished by means of a method for machining of a flat substrate having at least one layer, in that the substrate, configured as a strip, web or sheet is passed through at least one machining too, together with a filler material in the form of a strip, web or sheet, on different levels, the substrate is positioned and held, particularly in the region of the machining tool, at least one component of the machining tool, configured in punch-like manner, produces an opening, particularly a window, at a predeterminable location of the substrate, the component is subsequently moved into a region outside of the opening, and in a further stroke, an element corresponding to the cross-section of the opening is punched out of the filler material by the component of the machining tool, moved in the direction of the opening of the substrate, which is fixed in place, by the component, and the element is set into the opening of the substrate by the component.

Advantageous further developments of the object of the invention can be derived from the related dependent method claims.

This task is also accomplished by means of a device for machining of a flat substrate having at least one layer, having a machining tool containing at least one component configured in punch-like manner, a first guidance and transport device for a substrate configured in strip, web or sheet form, a second guidance and transport device for a filler material configured in strip, web or sheet form, wherein the first and the second guidance and transport device are disposed on different levels, and wherein the component can be moved relative to the substrate as well as relative to the filler material, in such a manner that an element cut out of the filler material can be inserted by the component into an opening previously introduced into the substrate.

Advantageous further developments of the device according to the invention can be derived from the dependent related device claims.

It is advantageous if the element punched out of the filler material is held within the opening, particularly the window, of the substrate having at least one layer, by means of clamping.

Assignment of the substrate to the filler material within the machining tool can be implemented as follows:
the substrate and the filler material can be passed through the machining tool parallel to one another, at a predeterminable distance,
the substrate and the filler material can be passed through the machining tool at any desired angle, preferably at a right angle to one another, at a predeterminable distance.

According to a further idea of the invention, the substrate and the filler material are passed through the machining tool intermittently.

In general, substrate and filler material consist of different materials. Depending on the subsequent purpose of use, it can be practical to produce the filler material from a transparent material, so that the region of the opening is translucent.

It is advantageous for the object of the invention if the substrate is configured in multiple layers, wherein all the layers are positioned and held in the region of the machining tool before introduction of the respective opening, and the element is placed within the common opening during the course of machining, in such a manner that it has clamping contact with at least one layer of the multi-layer substrate.

The device particularly comprises multiple cutting and guidance plates provided in the region of the machining tool, in order to be able to implement the corresponding machining steps, namely production of the opening in the substrate having at least one layer, punching out of the element from the filler material, as well as insertion of the element into the opening of the substrate, because these processes are carried out on different levels.

According to a further idea of the invention, multiple clamping elements are provided within the machining tool, which elements position and hold the substrate having at least one layer during the course of its machining. This is particularly advantageous if the substrate consists of multiple layers and no machining tolerances within the individual layers of the substrate are desired, so that the element can be introduced into the common opening of the multi-layer substrate in clamping manner, without problems.

The clamping elements are preferably activated pneumatically. At least one anvil strip that can be moved relative to the substrate is provided within the machining tool, which strip serves as a counter-bearing during introduction of the element into the opening of the substrate. The anvil strip can also be activated pneumatically, if necessary.

According to a further idea of the invention, the component is configured as a punching die, which not only produces the opening in the substrate but also cuts the element out of the filler material and inserts the same into the opening of the substrate.

The object of the invention is shown in the drawings, using an exemplary embodiment, and is described as follows. The figures show:

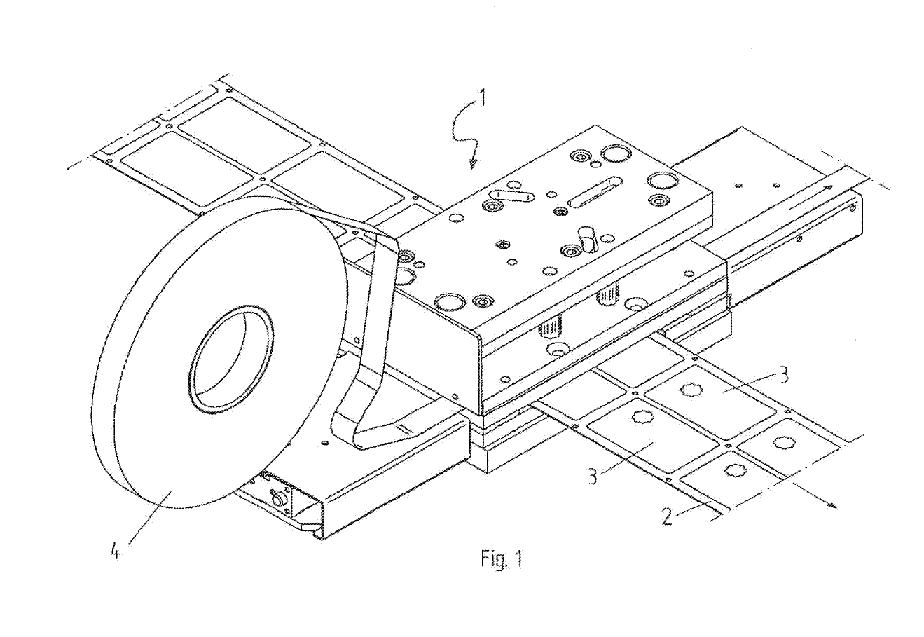

FIG. 1 schematic diagram of the device according to the invention;

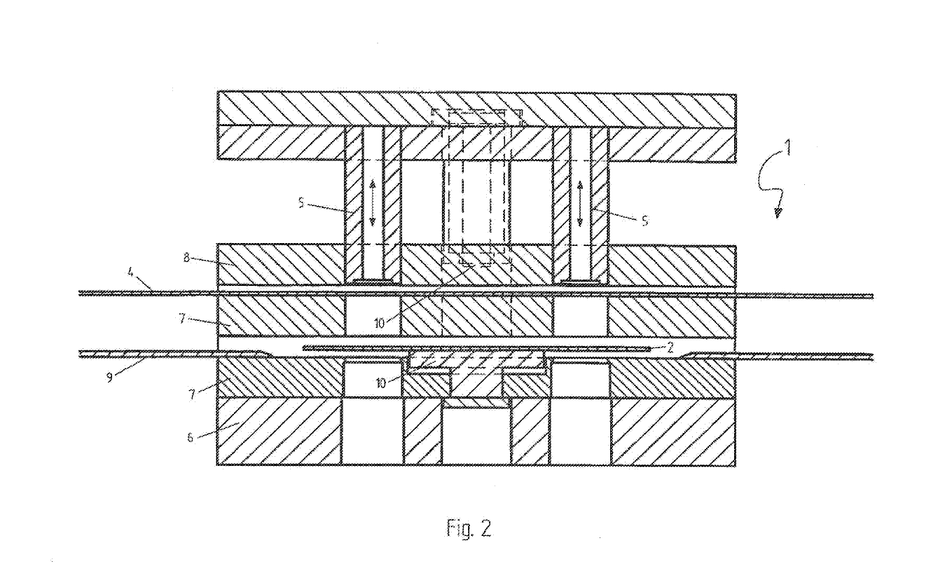

FIGS. 2 to 7 device according to FIG. 1 in different machining positions.

FIG. 1 shows the device according to the invention as a schematic diagram.

A multi-part machining tool 1 can be seen; its essential components will be described in greater detail in the following figures.

On the one hand, a strip-shaped substrate 2, having at least one layer, which substrate is supposed to contain two panels 3 disposed next to one another in this example. The substrate 2 can also be configured in web or strip form, with any desired number of panels. A wound-up filler material 4, also configured in strip form, is passed through the machining tool 1 at a right angle to the substrate 2, on a different level. Depending on the configuration of the machining tool 1 or of the entire machining machine, the filler material 4 can also be passed through the machining tool 1 parallel to the substrate 2, above or below the substrate 2.

FIGS. 2 to 7 show different machining states of the substrate 2 and of the filler material 4, respectively. The machining tool 1 shows the following elements/components: the substrate 2, the filler material 4, a component 5 configured as a punching die, a base plate 6, two cutting and guidance plates 7, 8, movable anvil strips 9, as well as clamping elements 10.

In FIG. 2, it can be seen that the punching die 5 is disposed within the machining tool 1 in a position that allows free movability both of the substrate 2 and of the filler material 4 within the machining tool 1.

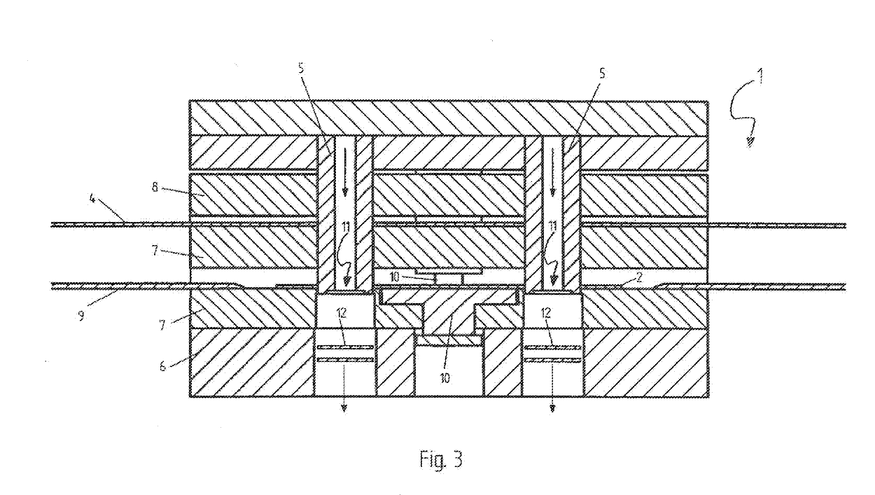

FIG. 3 shows the first work stroke of the punching die 5. The same cuts an element 12 corresponding to the contour of the punching die 5 out of the filler material 4. During a further stroke, the punching die 5 produces an opening 11, configured in window-like manner, within the substrate 2, and presses the element 12, punched out of the filler material 4, which element is not shown in any detail, through the opening 11 produced, so that it can fall through downward. For machining purposes, the substrate 2 is positioned and held within the machining tool by means of the clamping elements 10. This stroke takes place only a single time during the further machining step. The same holds true for introduction of a new substrate 2 or filler material 4, respectively, into the machining tool 1.

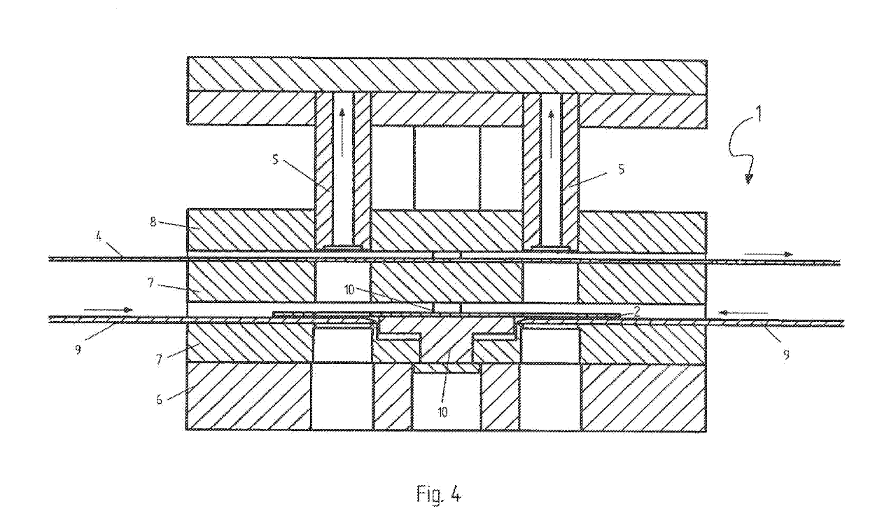

FIG. 4 shows that the punching die 5 is now back in a position that lies outside of the filler material 4, which lies above the substrate 2. In this position, the anvil strip 9 is pushed under the substrate 2, wherein the substrate 2 continues to be fixed in place by the clamping elements 10.

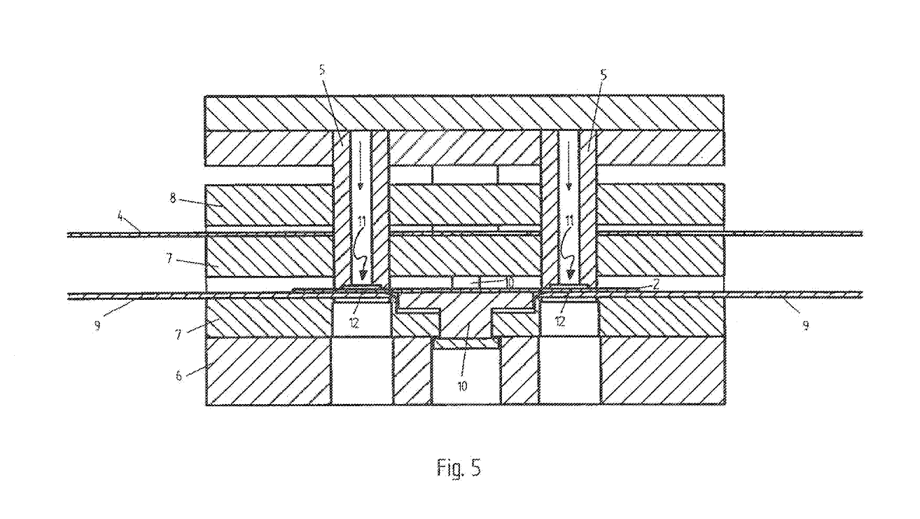

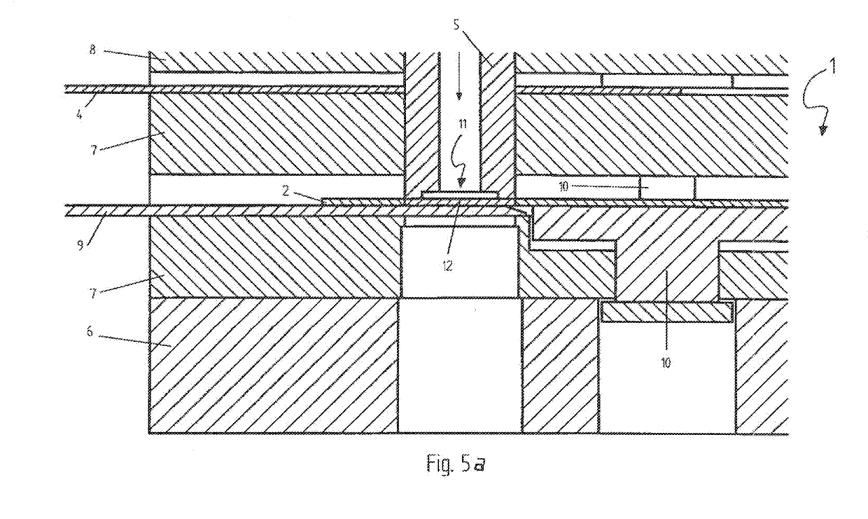

FIG. 5 shows a machining position in which the punching die 5 cuts an element 12 out of the filler material 4 and inserts the same into the previously produced opening 11 within the substrate 2, so that the element 12 is held in clamping contact with the substrate 2. In this process, the punching die 5 is moved toward the substrate 2 to such an extent that the anvil strip 9 prevents the element 12 from being pressed through the opening 11 in the substrate 2.

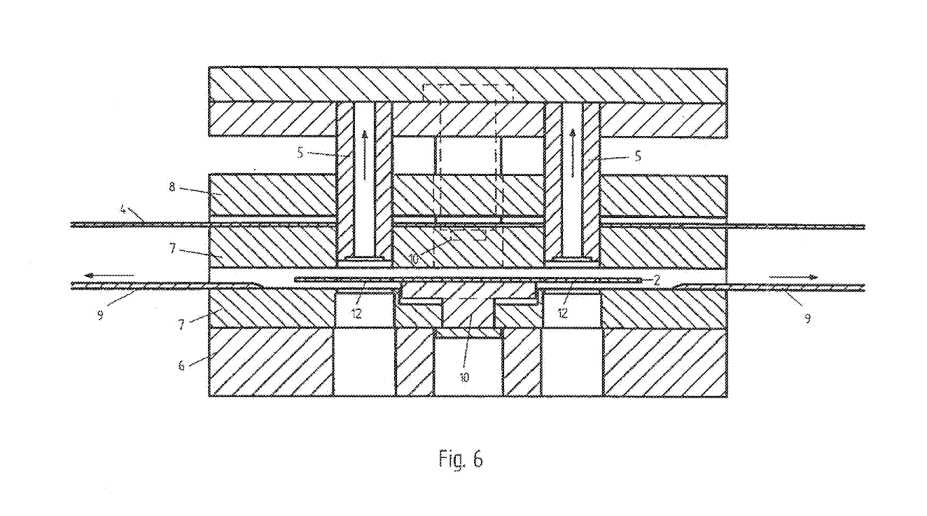

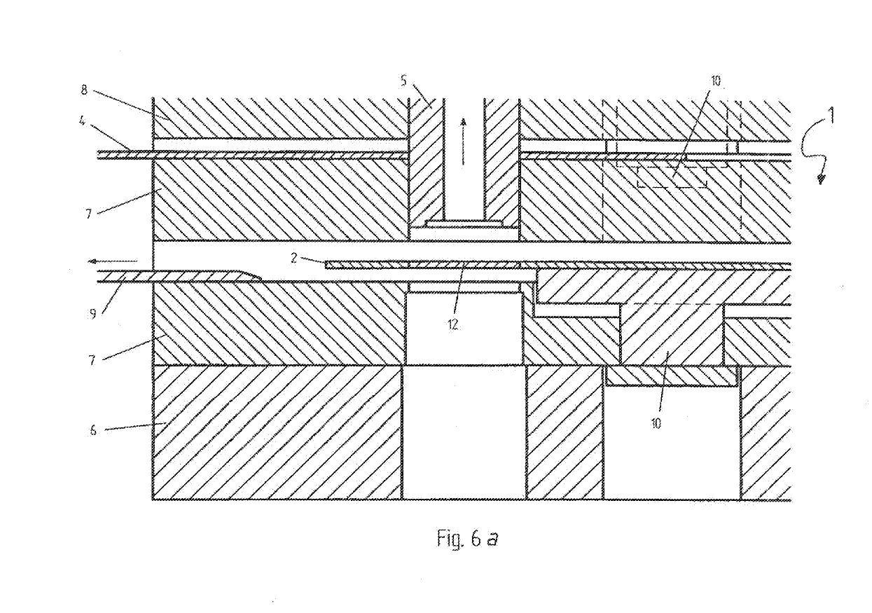

FIG. 6 shows a machining position in which the substrate 2 can be moved further in the transport direction, while the punching die 5 is held in a position in which the filler material 4 cannot be transported. Clamping of the substrate 2 has been cancelled out in FIG. 6, and the anvil strip 9 has been moved back into its starting position.

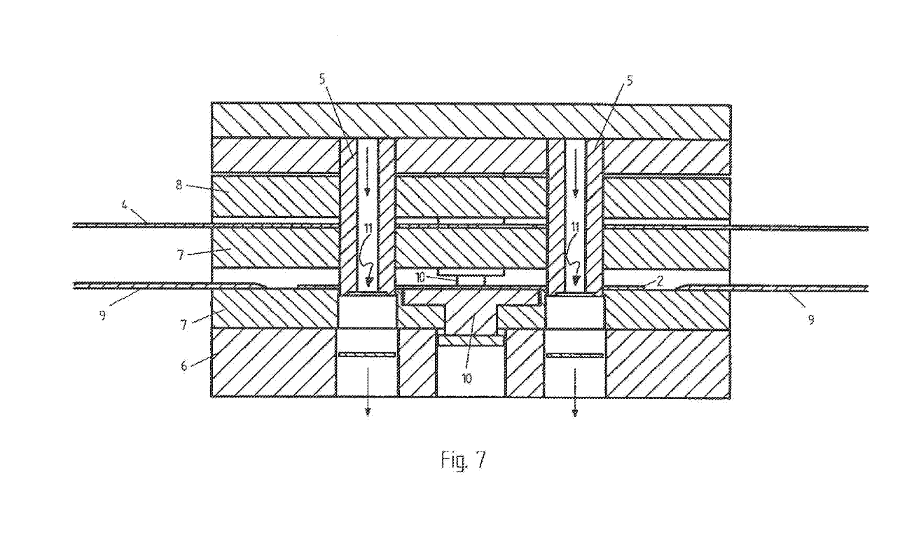

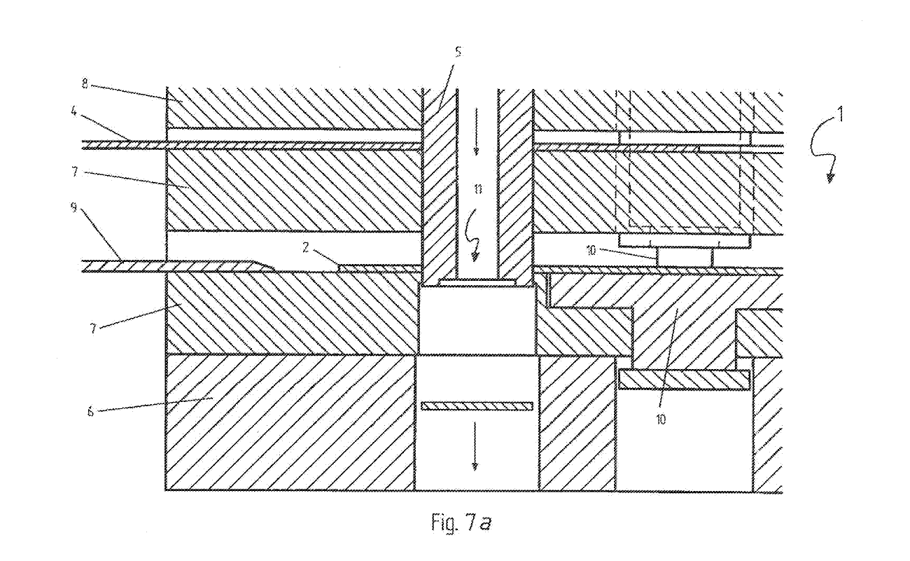

FIG. 7 shows a subsequent work step, in that a further opening 11 is cut out of the substrate 2, which has been clamped again. During intermittent operation, the representation in FIG. 4 then follows again for further machining of the substrate.

1: Method for machining of a flat substrate (2) having at least one layer, wherein the substrate (2), configured as a strip, web or sheet, is passed through at least one machining tool (1), together with a filler material (4) in the form of a strip, web or sheet, on different levels, the substrate (2) is positioned and held, particularly in the region of the machining tool (1), at least one component (5) of the machining tool (1), configured in punch-like manner, produces an opening (11), particularly a window, at a predeterminable location of the substrate (2), the component (5) is subsequently moved into a region outside of the opening (11), and in a further stroke, an element (12) corresponding to the cross-section of the opening (11) is punched out of the filler material (4) by the component (5) of the machining tool (1), moved in the direction of the opening (11) of the substrate (2), which is fixed in place, by the component (5), and the element (12) is set into the opening (11) of the substrate (2) by the component (5).

2: Method according to claim 1, wherein the element (12) is held within the opening (11), particularly the window of the substrate (2), by means of clamping.

3: Method according to claim 1, wherein the substrate (2) and the filler material (4) are passed through the machining tool (1) parallel to one another, at a predeterminable distance.

4: Method according to claim 1, wherein the substrate (2) and the filler material (4) are passed through the machining tool (1) at any desired angle, preferably at a right angle to one another, at a predeterminable distance.

5: Method according to claim 1, wherein the substrate (2) and the filler material (4) are passed through the machining tool (1) intermittently.

6: Method according to claim 1, wherein the filler material (4) is formed from a transparent material.

7: Method according to claim 1, wherein the substrate (2) is configured in multiple layers, wherein all the layers are fixed in place in the region of the machining tool (1) before introduction of the respective opening (11), and the element (12) is placed within the common opening (11) during the course of machining, in such a manner that it has clamping contact with at least one of the layers of the multi-layer substrate (2).

8: Device for machining of a flat substrate (2) having at least one layer, having a machining tool containing at least one component (5) configured in punch-like manner, a first guidance and transport device for the substrate (2) configured in strip, web or sheet form, a second guidance and transport device for a filler material (4) configured in strip, web or sheet form, wherein the first arid the second guidance and transport device are disposed on different levels, and wherein the component (5) can be moved relative to the substrate (2) as well as to the filler material (4), in such a manner that an element (12) cut out of the filler material (4) can be inserted by the component (5) into an opening (11) previously introduced into the substrate (2).

9: Device according to claim 8, wherein the machining tool (1) contains multiple cutting and guidance plates (7, 8).

10: Device according to claim 8, wherein clamping elements (10) are provided within the machining tool (1), which elements position and hold the substrate (2) during the course of its machining.

11: Device according to claim 8, wherein the clamping elements (10) can be activated pneumatically.

12: Device according to claim 8, wherein at least one anvil strip (9) that can be moved relative to the substrate (2) is provided within the machining tool (1), which strip serves as a counter-bearing during introduction of the element (12) into the opening (11) of the substrate (2).

13: Device according to claim 8, wherein the anvil strip (9) can be activated pneumatically.

14: Device according to claim 8, wherein the component (5) is configured as a punching die, which not only produces the respective opening (11) in the substrate (2) but also cuts the element (12) out of the filler material (4) and inserts the same into the opening (11) of the substrate (2).
